(19) United States
(12) Patent Application Publication
(10) Pub. No.: US 2007/0299372 A1
(43) Pub. Date: Dec. 27, 2007

(54) Foot sole massager

(76) Inventor: David Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/474,268

(22) Filed: Jun. 26, 2006

(51) Int. Cl. A61H 1/02

(52) U.S. Cl. 601/28; 601/27

(57) ABSTRACT

A foot sole massager comprised of a casing, a power unit in the casing, and a mobile part; the mobile part being driven by the power unit; the mobile part being comprised of multiple pieces and located at where in corresponding to toes of a user when stepping into the foot sole massager; the mobile part operating in a specific or a preset sequence to work out toes of the user to stimulate and enhance the circulation system of the user for the user to stay fit.

### FIELD OF THE INVENTION

The present invention is related to a foot sole massager, and more particularly, to one works out toes at the same time to stimulate and enhance circulation system for one to keep fit.

### BACKGROUND OF THE INVENTION

Whereas it is believed particularly in the oriental world that the sole of the foot controls the reflection areas corresponding to one's general body, there are many different types of sole massager generally available in the market either by vibration or by rollers, and some even by hydropathy. However, there has been the absence of achieving the health preservation purpose by means of working on the toes to stimulate one's circulation system. Since toes are communicated with many arteries and veins in a human body, skillful working out the toes by stretching, twisting or tuning them will help the circulation system for one to always keep fit.

### SUMMARY OF THE INVENTION

The primary purpose of the present invention is to provide a foot sole massager that works on the toes driven by a power unit to effectively promote one's circulation system for staying fit.

Another purpose of the present invention is to provide a foot sole massager that works on the toes to enhance one's circulation system and the installation and operating sequence of the mobile part of the present invention may be designed depending on the needs of the manufacturer or the user.

Another purpose yet of the present invention is to provide a food sole massager that works on the toes to enhance one's circulation system and allows excellent results, easy operation, portability, and wide applications.

To achieve all these purpose, a power unit is disposed in the foot sole massager to drive a mobile part; the mobile part is exposed from the foot sole massager and provided at where toes are located when the user steps into the foot sole massager; the power unit drives the mobile part to work out on the toes in a specific or preset sequence.

### BRIEF DESCRIPTION OF THE DRAWINGS

FIG. 1 is a sectional view of a preferred embodiment of the present invention.

FIG. 2 is a perspective view of the preferred embodiment of the present invention.

FIG. 3 is a schematic view showing an operating status of the preferred embodiment of the present invention.

### DETAILED DESCRIPTION OF THE PREFERRED EMBODIMENTS

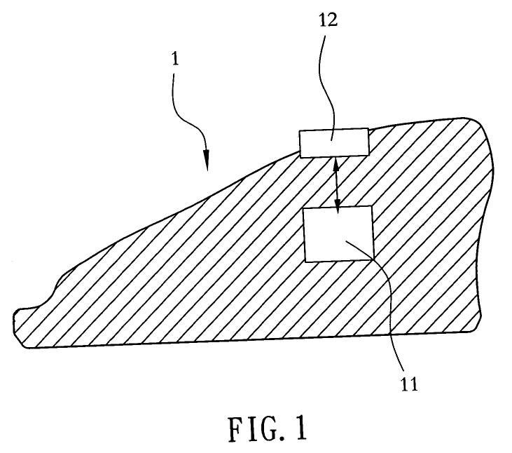

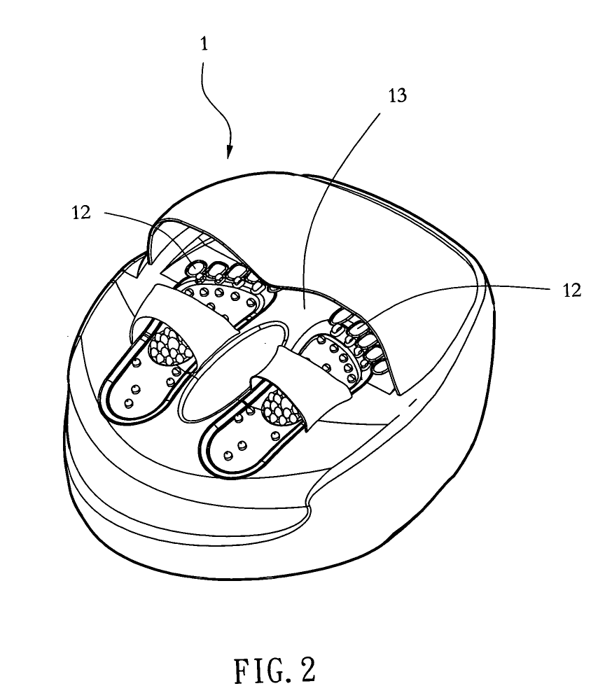

Referring to FIGS. 1 and 2 for a sectional view and a perspective view of a preferred embodiment of the present invention, a foot sole massager 1 of the preferred embodiment of the present invention is provided with a built in power unit 11 to drive a mobile part 12 comprised of multiple pieces by means of solenoid, worm gear or motor vibration; the mobile part 12 is exposed out of a casing 13 of the foot sole massager 1 and disposed at where toes are located when the user puts his both feet into the foot sole massager 1. The number of the pieces of the mobile part 12 may vary depending on the manufacturer's specification or needs of the user.

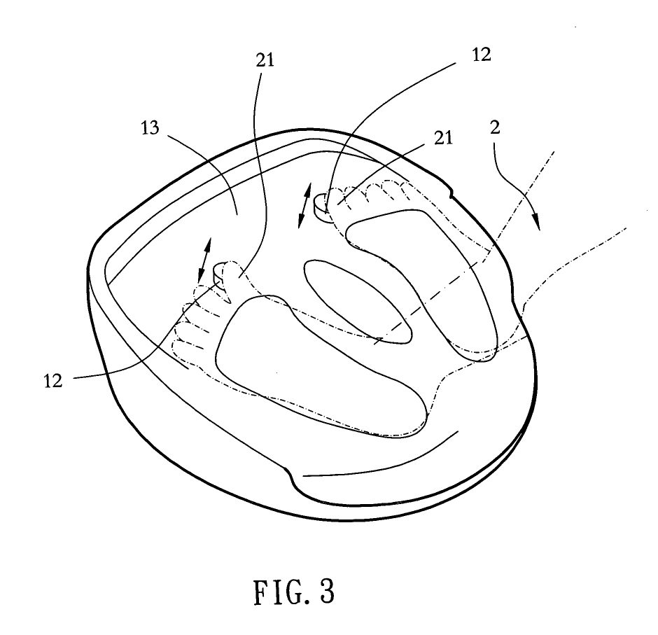

As illustrated in FIG. 3 for a schematic view showing an operating status of the preferred embodiment of the present invention; the user has both feet 2 stepped onto the foot sole massager 1; the power unit 11 drives the mobile part 12; the mobile part 12 operates according to a specific or a preset sequence; and all the toes 21 are pulled, twisted or turned by the mobile part 12 to stimulate the circulation system of the user for staying fit.

The prevent invention provides an innovative structure of a foot sole massager, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A foot sole massager comprised of a casing, a power unit in the casing, and a mobile part; the mobile part being driven by the power unit; the mobile part being comprised of multiple pieces and located at where in corresponding to toes of a user when stepping into the foot sole massager.

2. A foot sole massager of claim 1, wherein the power unit drives the mobile part by means of solenoid, worm gear or motor vibration.

3. A foot sole massager of claim 1, wherein the number of the pieces of the mobile part varies as required.

4. A foot sole massager of claim 1, wherein the mobile part operates in a specific sequence.

5. A foot sole massager of claim 4, wherein the user presets the operating sequence of the mobile part as desired.
